(19) United States
(12) Patent Application Publication
(10) Pub. No.: US 2002/0095516 A1
(43) Pub. Date: Jul. 18, 2002

(54) Internet telephone system and internet telephone apparatus

(76) Inventor: Noriaki Nada, Fukuoka (JP)

Correspondence Address: RATNER AND PRESTIA, One Westlakes, Berwyn, Suite 301, P.O. Box 980, Valley Forge, PA, 19482-0980, US

(21) Appl. No.: 09/963,311

(22) Filed: Sep. 26, 2001

(30) Foreign Application Priority Data
Sep. 26, 2000 (JP) 2000-292061

(51) Int. Cl. H04L 12/66; G06F 15/16

(52) U.S. Cl. 709/245; 370/352; 709/227; 379/900

(57) ABSTRACT

An Internet telephone system and telephone apparatus for making an Internet telephone call by entering a telephone number. The system includes a telephone set, a modem, a partner side telephone set, its modem, and a server connected to the Internet for registering a telephone number and an IP address corresponding to the telephone number by relating to each other. The modem, when assigned with an IP address from an Internet service provider, transmits this IP address and the telephone number of the telephone set connected to itself to the server, and registers them. The telephone set and the modem, receiving the telephone number of the partner side telephone set, make a connection operation by acquiring the IP address corresponding to the partner telephone number from the server.

### FIELD OF THE INVENTION

The present invention relates to an Internet telephone system and an Internet telephone apparatus using the Internet.

### BACKGROUND OF THE INVENTION

At the present, the following Internet telephone system is put in practical use.

From an ordinary telephone set, a call is made to a calling side Internet telephone gateway having a function of converting audio into a digital signal and connecting a public switching network (PSN) and the Internet. Relaying a long distance therefrom through the Internet, an ordinary telephone set at the partner is called through a destination side Internet telephone gateway. This system contributes to saving of expenses of long distance call.

Recently, as shown in FIG. 5, by furnishing a communication modem of asymmetric digital subscriber line (ADSL) system with a function of mutually converting audio and a digital signal, an Internet telephone system usable all day is also put in practical use. As known well, the ADSL is used for all-day connection of a personal computer to the Internet and enables broadband data communications in a general telephone line.

FIG. 5 shows a configuration of a conventional Internet telephone system.

This diagram shows an example of Internet telephone system using the ADSL modem used for all-day connection to the Internet.

In FIG. 5, at the calling side, an ADSL modem 22 is connected to an ordinary telephone set 21 and a personal computer 23.

The calling side the ADSL modem 22 communicates with a destination side ADSL modem 30 by way of a calling side local telephone network 24, local office equipment (network management equipment) 25, the Internet 26, a destination side local office equipment 27, and a destination side local telephone network 28. Herein, the local office equipment 25 connects between the calling side local telephone network 24 and the Internet. The Internet 26 relays the call thorough a long distance. The local office equipment 27 connects between the destination side local telephone network 28 and the Internet 26.

At the destination side, a telephone set 29 and a personal computer 31 are connected to the ADSL modem 30. The telephone set 29 has a handset 32.

The ADSL modem 22 and ADSL modem 30 have a memory unit (not shown) for storing an IP address of the partner on the Internet corresponding to the telephone number of the partner.

In the Internet telephone system having such a configuration, the operation for making a call by using the Internet is explained.

At the calling side, when the telephone number of the destination side telephone set 29 is entered in the telephone set 21, the information of the entered telephone number is sent to the ADSL modem 22. The ADSL modem 22 requests a connection to the ADSL modem 30 by using the IP address of the destination side ADSL modem 30 stored in relation to the telephone number of the destination side telephone set 29.

At the destination side, the ADSL modem 30 receives a connection request from the calling side ADSL modem 22, and generates a telephone incoming signal, and informs the connected telephone set 29 of the connection request incoming. At this time, the telephone set 29 rings the bell, and the handset 32 is lifted. Thus, the conversation is started.

In such conventional Internet telephone system, the user is required:

(1) To confirm beforehand that the intended partner has the ADSL modem conforming to the Internet telephone.

(2) To check the IP address of the partner, and store the telephone number of the partner and the IP address relating to each other in the user's own ADSL modem.

(3) To inform all partners of the Internet telephone call of the new IP address by using the electronic mail or telephone when the user's own IP address is changed, thus requesting the partners to update the content stored in the ADSL modem, which takes too much time and labor in updating the partners and memory contents.

### SUMMARY OF THE INVENTION

It is hence a primary object of the invention to present an Internet telephone system capable of using the Internet telephone only by entering an ordinary telephone number without considering the status of the partner.

In the Internet telephone system of the invention, at the calling side, the modem is coupled with the telephone set, and communicates with the Internet. At the destination side, too, the modem is coupled with the telephone set, and communicates with the Internet. A server is connected to the Internet, and registers the telephone numbers of the telephone sets, and the IP addresses of the modems corresponding to the telephone numbers.

Further, at the calling side, after the IP address is assigned, the modem transmits the telephone number of the telephone set and the assigned IP address to the server, and registers them in the server. Moreover, at the calling side, when the telephone number of the telephone set at the destination side is entered in the telephone set, the IP address corresponding to the telephone number of the telephone set at the destination side is acquired from the server, and the connection operation is started.

The invention presents an Internet telephone apparatus, including the modems and telephone sets, for operating in this system.

It hence realizes an Internet telephone system capable of using the Internet telephone for saving call expenses only by entering an ordinary telephone number without considering the status of the partner.

### BRIEF DESCRIPTION OF THE DRAWINGS

FIG. 1 shows a configuration of Internet telephone system in embodiments 1 to 6 of the invention.

FIG. 2 is a block diagram showing a modem for composing the Internet telephone system in embodiments 2 to 6 of the invention.

FIG. 3 is a block diagram showing a modem using a CATV interface.

FIG. 4 shows a configuration of Internet telephone system in embodiment 7 of the invention.

FIG. 5 shows a configuration of a conventional Internet telephone system.

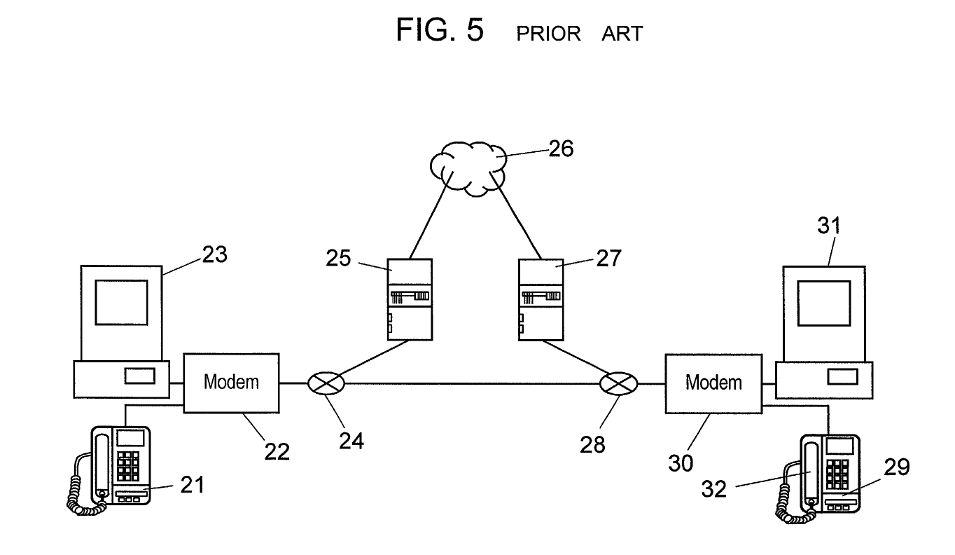

### DESCRIPTION OF THE PREFERRED EMBODIMENTS

The following examples relate to a system for using the Internet telephone automatically, only by entering a telephone number, without having to judge whether the telephone of the partner is accessible to the Internet or not.

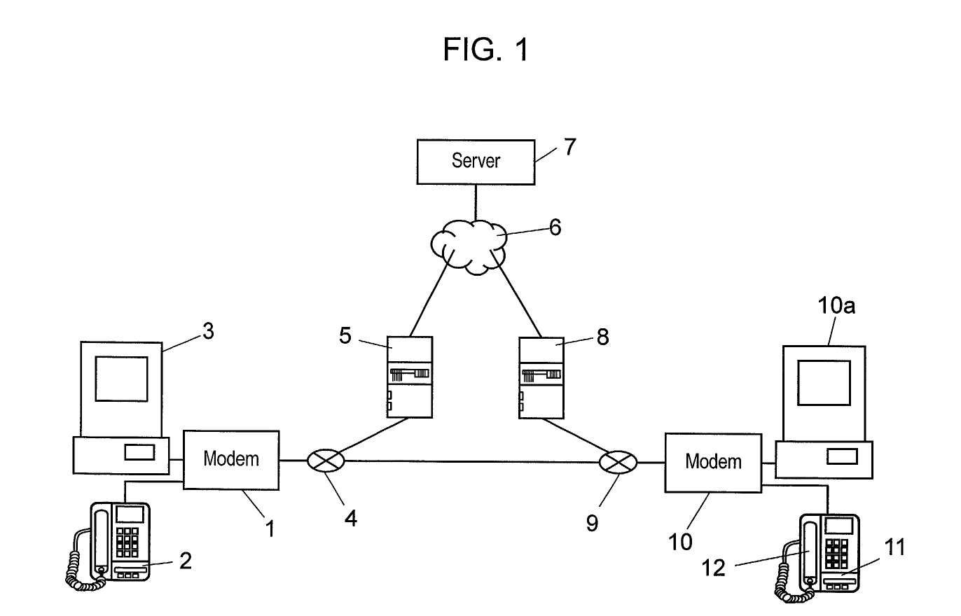

Embodiments of the invention are described below while referring to FIG. 1 to FIG. 4.

(Embodiment 1)

FIG. 1 shows a configuration of Internet telephone system in embodiments 1 of the invention.

In FIG. 1, at the calling side, a modem 1 has an Internet telephone function, and is connected with a telephone set 2 and a personal computer 3.

Calling side local office equipment (network management office equipment) 5 is connected to a local telephone line 4 and the Internet 6. The Internet 6 relays a call through a long distance. A server 7 has a memory unit for registering the telephone number sent from the user's modem and the IP address by relating to each other. At the destination side, local office equipment 8 is connected to a destination side local telephone network 9 and the Internet 6.

At the destination side, a modem 10 has an Internet telephone function, and is connected with a telephone set 11 and a personal computer 10a. The telephone set 11 includes a handset 12.

In the Internet telephone system having such a configuration, the operation is explained below.

First, when the power source is turned on, the modem 1 starts to communicate with the local office equipment 5 installed at an access point of an Internet connection service provider. Next, the modem 1 is assigned with a unique IP address from the Internet service provider, and is connected to the Internet 6. Once assigned with the IP address, the modem 1 automatically transmits the telephone number of the telephone set 2 connected to itself and the IP address assigned to itself, to the server 7 through the Internet 6. As a result, the telephone number of the calling side telephone set 2 and the assigned IP address are registered in the server 7.

The destination side modem 10 also transmits the telephone number of the telephone set 11 and the IP address assigned to itself to the server 7 in the same procedure, and they are registered in the server 7.

The operation for making a call by using the Internet 6 in this state is explained.

From the calling side telephone set 2, when the telephone number of the destination side telephone set 11 is entered in the modem 1, the modem 1 accesses the server 7. Next, the modem 1 receives the information of IP address of the modem 10 corresponding to the telephone number of the telephone set 11 from the telephone number information of the destination side telephone set 11 registered in the server 7. Further, using the received IP address, the modem 1 transmits a connection request to the destination side modem 10 through the Internet 6. When receiving the connection request from the calling side modem 1, the destination side modem 10 generates a telephone incoming signal. This incoming signal is transmitted to the telephone set 11, and rings its bell. The destination side user lifts the handset 12 of the telephone set 11, and starts to talk.

In this embodiment, as described herein, when each modem acquires the IP address, mutual IP addresses are registered in relation to the telephone numbers in the common server 7 beforehand.

In this configuration, unlike the prior art, it saves the labor of storing the telephone number and IP address of the partner by relating to each other in the own modem by investigating the IP address of the partner beforehand for making a telephone call by using the Internet. When the own IP address is changed, it also saves the complicated labor of informing all partners of the Internet telephone call of the new IP address by using the electronic mail or telephone, thus requesting the partners to update the content stored in the modem.

(Embodiment 2)

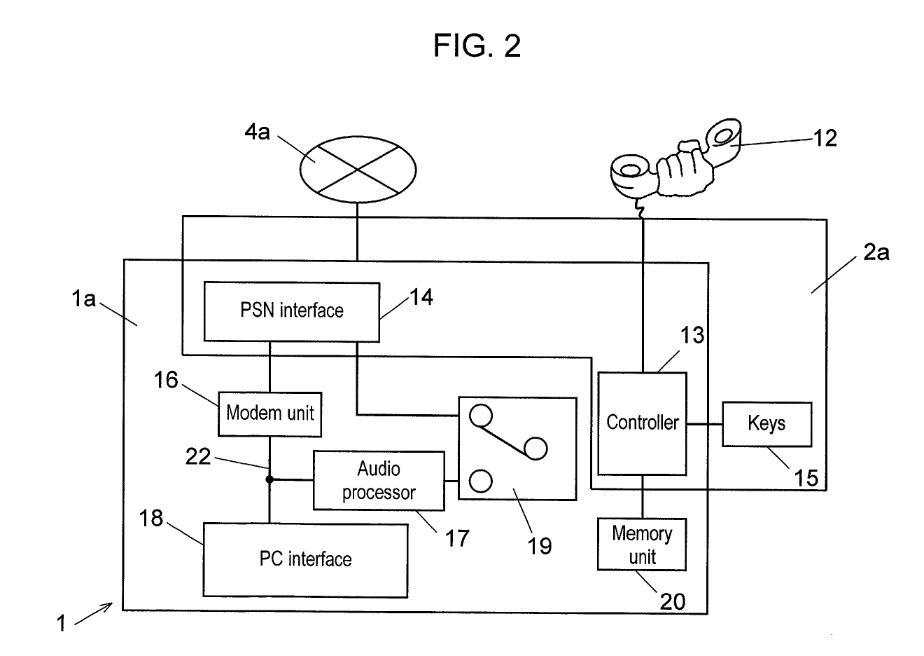

FIG. 2 is a block diagram showing a modem for constituting an Internet telephone system according to embodiment 2 of the invention, in which the modem has a telephone function.

In FIG. 2, a calling side modem 1 includes a modem block la and a telephone block 2a. A controller 13 controls the entire apparatus. Keys 15 are used for entering a telephone number. A modem unit 16 mutually converts a digital signal 22 and a data communication signal. An audio processor 17 mutually converts an audio signal and the digital signal 22. A transmission line switch 19 changes over the conversation between via the Internet and via the public switching network. A memory unit 20 stores the data. The modem block la further includes a personal computer interface 18. The telephone block 2a includes a handset 12. The modem 1 communicates with the public switching network (PSN) 4a through a PSN interface 14.

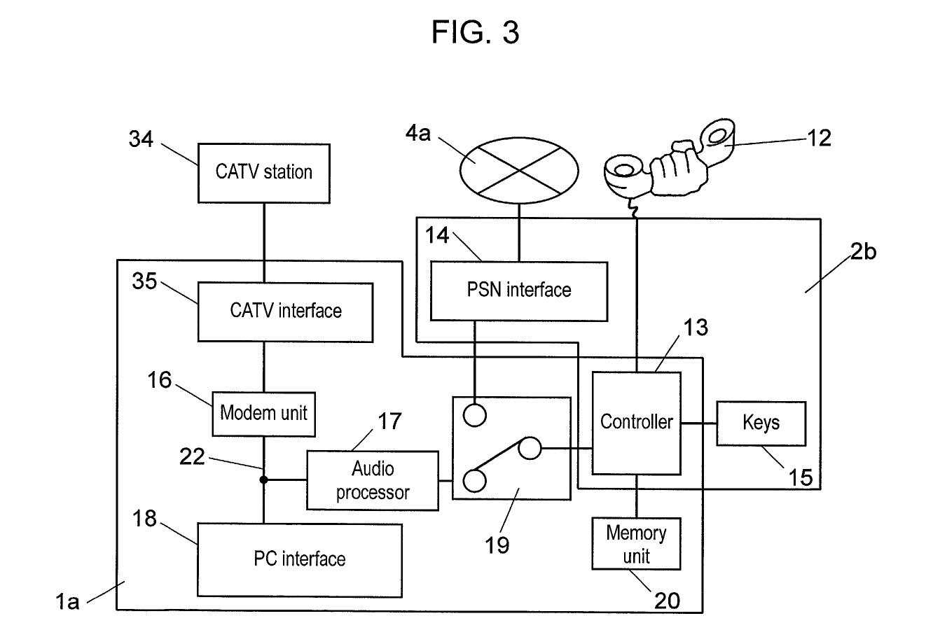

In this embodiment, the modem is not limited to the modem for xDSL such as ADSL using general telephone line for audio communication for the Internet connection, symmetric (SDSL), or high bit rate digital subscriber line (HDSL). As shown in FIG. 3, a cable modem using a CATV station 34 may be used for the Internet connection.

FIG. 3 is a block diagram showing a modem using a CATV interface 35.

Any type of telephone can be used, including the cordless telephone, facsimile apparatus with telephone, and telephone with browser function. This is the same manner in the following embodiments 3 to 7.

In the modem having such a configuration, the modem block la and telephone block 2a can be used commonly by using the controller 13 and PSN interface 14. Therefore, in the modem of the embodiment, the cost is saved as compared with the case of using an independent modem and a telephone set.

(Embodiment 3)

The configuration of an Internet telephone system according to embodiment 3 of the invention is the same manner as shown in FIG. 1 or FIG. 2, and its explanation is omitted. This embodiment differs in the operation of the calling side modem 1 from that in embodiment 1 or 2.

Regarding the Internet telephone system of the embodiment, the operation is explained.

In FIG. 1, a telephone number of the destination side telephone set 11 is entered in the calling side telephone set 2. The modem 1 accesses the server 7 to check if the IP address corresponding to the telephone number is present or not. At this time, if a response from the server 7 is not given to the modem 1 within a predetermined time due to circuit trouble or machine failure, the following operation is executed.

The controller 13 shown in FIG. 2 changes over the transmission line switch 19 from the audio processor 17 side to the PSN interface 14 side. Thus, a call is transmitted to the partner through the PSN.

Therefore, if not replied from the server 7, the user can talk to the partner securely.

(Embodiment 4)

The configuration of an Internet telephone system according to embodiment 4 of the invention is same as shown in FIG. 1 or FIG. 2, and its explanation is omitted. This embodiment differs in the operation of the calling side modem 1 from that in embodiments 1 to 3.

Regarding the Internet telephone system of the embodiment, the operation is explained.

In FIG. 1, a telephone number of the destination side telephone set 11 is entered in the calling side telephone set 2. The modem 1 accesses the server 7 to check if the IP address corresponding to the telephone number is present or not. At this time, if there is no IP address corresponding to the telephone number of the partner in the server 7, the following operation is executed.

The controller 13 shown in FIG. 2 judges that the partner does not have an Internet telephone, and changes over the transmission line switch 19 from the audio processor 17 side to the PSN interface 14 side. Thus, a call is made to the partner through the PSN.

Therefore, the user can make a telephone call in a conventional procedure without knowing whether the partner has an Internet telephone or not.

(Embodiment 5)

The configuration of an Internet telephone system according to embodiment 5 of the invention is the same manner as shown in FIG. 1 or FIG. 2, and its explanation is omitted. This embodiment differs in the operation of the calling side modem 1 from that in embodiments 1 to 4.

Regarding the Internet telephone system of the embodiment, the operation is explained.

In FIG. 1, a telephone number of the destination side telephone set 11 is entered in the calling side telephone set 2. The modem 1 accesses the server 7 to check if the IP address corresponding to the telephone number is present or not. Next, the modem 1 receives the information of the IP address of the destination side modem 10 from the server 7. Using the received IP address, the modem 1 sends a connection request to the destination side modem 10. At this time, suppose a response from the destination side modem 10 is not given within a predetermined time due to a circuit trouble or machine failure. The controller 13 changes over the transmission line switch 19 from the audio processor 17 side to the PSN interface 14 side, thereby controlling to make a call to the partner through the PSN.

Therefore, if not replied from the destination side modem 10, the user can talk to the partner securely.

(Embodiment 6)

The configuration of an Internet telephone system according to embodiment 6 of the invention is the same manner as shown in FIG. 1 or FIG. 2, and its explanation is omitted. This embodiment differs in the operation of the calling side modem 1 from that in embodiments 1 to 5.

Regarding the Internet telephone system of the embodiment, the operation is explained.

In FIG. 1, first, power source of the calling side modem 1 is turned on to communicate with the calling side local office equipment 5 provided at an access point of an Internet connection service provider, and a unique IP address is assigned from the Internet connection service provider. Next, the modem 1 transmits the telephone number of the telephone set 2 connected to itself and the IP address assigned to itself automatically to the server 7, and registers them in the server 7. At this time, if not replied from the server 7 within a predetermined time due to a circuit trouble or machine failure, the modem 1 once holds the job for the registration. The modem 1 stores the information to be transmitted and registered in the server 7 in the memory unit 20 shown in FIG. 2. When the telephone number of the partner is entered in the telephone set 2 connected to the modem 1, the registration information is transmitted again to the server 7.

Thus, being securely registered in the server 7, the Internet telephone can be utilized.

(Embodiment 7)

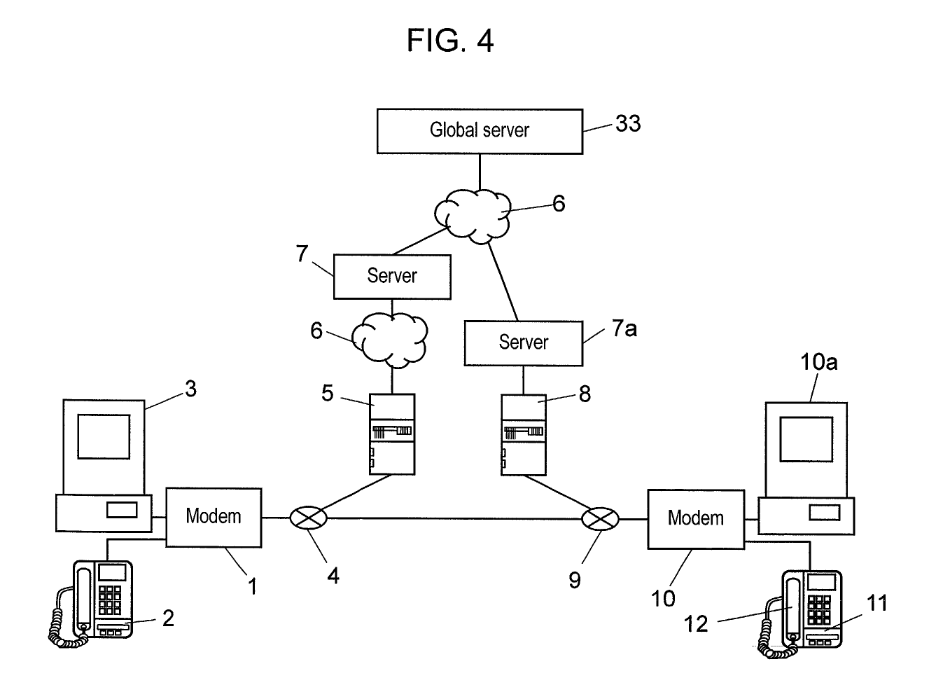

FIG. 4 shows a configuration of an Internet telephone system according to embodiment 7 of the invention.

As shown in FIG. 4, the calling side includes the modem 1, telephone set 2, personal computer 3, local telephone network 4, local office equipment (network management equipment) 5, Internet 6 and server 7. The destination side includes the local office equipment (network management equipment) 8, local telephone network 9, modem 10, personal compute 10a, telephone set 11, and handset 12. They are the same members as in FIG. 1. Therefore, the same reference numerals are given and the explanation is omitted.

A server 7a is disposed between the partner side network management equipment 8 and the Internet 6. In a global server 33, a global IP address is registered.

Regarding the Internet telephone system of the embodiment, the operation is explained.

The modem communicates with the destination side local office equipment 8 provided at an access point of an Internet connection service provider, and is assigned with an IP address. At this time, the IP address assigned from the Internet service provider may be a local IP address usable only within a specific network, instead of a global IP which is unique in the world.

In such a case, as shown in FIG. 4, the server 7a stores the local IP address of the destination side modem 10 and the telephone number of the destination side telephone set 11 by relating to each other.

The host global server 33 registers the global IP address of the server 7a and the telephone number of the destination side telephone set 11 in itself by relating to each other.

When the IP address of the destination side modem 10 is inquired from the calling side modem 1 to the server 7, the server 7 transfers the inquiry information to the host global server 33. Thus, the modem 1 obtains the IP address information of the server 7a, and sends a connection request to the server 7a.

The server 7a converts the telephone number into the local IP address of the destination side modem 10, and relays the connection request.

Thus, even in the local IP address environments, the Internet telephone system can be utilized.

What is claimed is:

1. An Internet telephone system for making a telephone call through Internet, comprising:
a) a first telephone set,
b) a first modem coupled to the first telephone set for communicating with the Internet,
c) a second telephone set,
d) a second modem coupled to the second telephone set for communicating with the Internet, and
e) a server connected to the Internet for storing a telephone number and an IP address corresponding to the telephone number,
wherein said first modem, after being assigned with an IP address, transmits a telephone number of the first telephone set and the assigned IP address to the server to register the telephone number and the assigned IP address in the server, and acquires an IP address corresponding to a telephone number of the second telephone set from the server, when the telephone number of the second telephone set is entered in the first telephone set, and then connects to said second modem.

2. The Internet telephone system of claim 1,
wherein said first modem and said first telephone set include a common function.

3. The Internet telephone system of claim 1,
wherein said first modem communicates with said second modem through a public switching network if not replied from the server.

4. The Internet telephone system of claim 1,
wherein said first modem communicates with said second modem through a public switching network if the IP address corresponding to the telephone number of the second telephone set is not received from the server.

5. The Internet telephone system of claim 1,
wherein said first modem communicates with said second modem through a public switching network if not replied from the second modem when making a connection operation to the second modem by obtaining the IP address corresponding to the telephone number of the second telephone set from the server.

6. The Internet telephone system of claim 1,
wherein said first modem stores registration information if not replied from the server after transmitting registration information to the server, and transmits the registration information again to the server to register the registration information in the server when the telephone number is entered in the first telephone set.

7. The Internet telephone system of claim 1, further comprising:
f) a host server of the server,
wherein if an IP address of the server is a local IP address usable within a specific network, a unique IP address of the server and the telephone number registered in the server are registered in the host server by relating to each other.

8. An Internet telephone apparatus for making a telephone call through Internet, comprising:
a) a telephone set, and
b) a modem coupled to the telephone set for communicating with the Internet,
wherein said modem, after being assigned with the IP address, transmits a telephone number of the telephone set and the assigned IP address to a server connected to the Internet to register the telephone number and the assigned IP address in the server, and acquires an IP address corresponding to a telephone number of a destination side from the server, when the telephone number of the destination side is entered in the telephone set, and then makes a connection operation.

9. The Internet telephone apparatus of claim 8,
wherein said telephone apparatus communicates with the destination side through a public switching network if not replied from the server.

10. The Internet telephone apparatus of claim 8,
wherein said telephone apparatus communicates with the destination side through a public switching network if the IP address corresponding to the telephone number of the destination side is not received from the server.

11. The Internet telephone apparatus of claim 8,
wherein said telephone apparatus communicates with the destination side through a public switching network if not replied from the destination side, when making a connection operation to the destination side by obtaining the IP address corresponding to the telephone number of the destination side from the server.

12. The Internet telephone apparatus of claim 8,
wherein said telephone apparatus stores registration information if not replied from the server after transmitting registration information to the server, and transmits the registration information again to the server to register the registration information in the server when the telephone number is entered in the telephone set.

13. The Internet telephone apparatus of claim 8,
wherein if the IP address of the destination side is a local IP address, an IP address of other server connected to the destination side, and the telephone number of the destination side are acquired from a host server of the server, and a connection operation is made.
